(19) United States
(12) Patent Application Publication
(10) Pub. No.: US 2026/0131739 A1
(43) Pub. Date: May 14, 2026

(54) COUPLING MECHANISM TO COUPLE PAYLOAD(S) WITH A VEHICLE

(71) Applicant: Tesseract Ventures, LLC, Overland Park, KS (US)

(72) Inventors: John Boucard, Kansas City, MO (US); Jason Harrell, Tampa, FL (US); Ian Koelle, Lutz, FL (US); Greg Lorrett, Kansas City, MO (US); Griffin Garbut, Kansas City, MO (US)

(73) Assignee: Tesseract Ventures, LLC, Overland Park, KS (US)

(21) Appl. No.: 19/374,779

(22) Filed: Oct. 30, 2025

Related U.S. Application Data
(60) Provisional application No. 63/717,975, filed on Nov. 8, 2024.

(51) Int. Cl. B60R 9/00; B64U 60/30

(52) U.S. Cl. CPC B60R 9/00; B64U 60/30

(57) ABSTRACT

A coupling mechanism is provided for coupling a vehicle with a payload. A latch mechanism includes a spring-loaded latch. The spring-loaded latch can be operable to transition between a locked configuration and an unlocked configuration. A tension connection can be operable to hold the latch mechanism under a tension force. When the payload receives a release force, the spring-loaded latch transitions to the unlocked configuration such that the payload is releasable from the vehicle.

### CROSS-REFERENCE TO RELATED APPLICATION

This application claims the benefit of U.S. Provisional Ser. No. 63/717,975 , filed in the U.S. Patent and Trademark Office on Nov. 8, 2024, which is incorporated herein by reference in its entirety for all purposes.

### FIELD

The present disclosure is directed to a coupling mechanism operable to couple one or more payloads with a vehicle, such as a drone.

### BACKGROUND

Vehicles such as drones have seen rapid technological advancement and widespread adoption across various industries, including agriculture, filmmaking, and delivery services. Drones have also revolutionized modern warfare with their versatility and capabilities.

Drones can be equipped with payloads that can include various sensors, cameras, and sometimes weapons, allowing them to perform reconnaissance, surveillance, and combat tasks without risking human lives. Drones have evolved to include more capabilities, for example being integral for modern military operations as drones can offer real-time data collection and precision strikes against enemy targets.

### BRIEF DESCRIPTION OF THE DRAWINGS

FIG. 1 illustrates a vehicle.

FIG. 2 illustrates a payload.

FIG. 3 illustrates the payload coupled with the vehicle.

FIG. 4 illustrates the vehicle lowered such that the payload abuts against a surface.

FIG. 5 illustrates the payload releasing from the vehicle while the vehicle lifts away from the surface.

### DESCRIPTION

Payloads need to be quickly and easily coupled and deployed to maximize the capabilities of the vehicle carrying the payload. This disclosure provides a coupling mechanism for coupling a vehicle with a payload. The coupling mechanism functions as a lockable attachment mechanism that deploys upon vertical compression on the underside of the payload volume. The design operates by hinging about an angled alignment fin. On an opposing side, a spring-loaded latch can be used to lock the payload in place, which once compressed is held under tension by a compression contact in a tension connection. These contacts can also be used to supply the payload with power, ground, data, and/or clock connections from the vehicle. When the underside of the payload is pushed up into the vehicle—presumably by contacting the surface below it—the payload pushes up into the vehicle, causing the front latch to release free of the vehicle latch bar.

The presently disclosed system 1 includes a vehicle 10 and one or more payloads 20. While the disclosure discusses one payload 20, in some examples, more than one payload 20 may be coupled with and/or released from the vehicle 10 without deviating from the scope of the disclosure. The vehicle 10 can include a drone, an aerial vehicle, a ground vehicle, an underwater vehicle, etc. The vehicle 10 can be operable to be coupled with the payload 20, transport the payload 20 to a predetermined location, and release the payload 20 to be deployed at the predetermined location. While the disclosure discusses the payload 20 being coupled directly with the vehicle 10, in some examples, the payload 20 can be coupled with other components of the vehicle 10, components coupled with the vehicle 10, cases, and/or any other medium to couple with and deploy the payload 20.

In some examples, the payload 20 can include sensors, ballistics, ammunition, controllers, processors, and/or explosives. This function of detachably coupling payload(s) 20 can expand the utility of the vehicle 10 for carrying a variety of custom sensors, explosive charges, directed ballistics, etc. For example, custom sensors can be utilized for mission specific objectives such as motion, gas, and/or radiation detection. As an explosive charge, the payload 20 can provide precision strikes that can target enemy assets and/or infrastructure. In some examples, deployment of non-explosive projectiles can be used for tactical advantages such as disabling enemy equipment, distraction, and/or marking targets.

In some examples, the vehicle 10 can be operable to carry a payload 20 for resupply. One of the crucial challenges that military forces often face in the field is the resupply of essential items such as ammunition, medical aid, food, water, and equipment. This is especially true in scenarios where personnel are deployed in hostile, hard-to-reach, or geographically challenging terrains. The vehicle 10, with its capability to deliver critical supplies, represents a significant advancement in addressing this challenge. In some examples, a plurality of vehicles 10 can work together to carry a larger payload 20 (e.g., each vehicle 10 is coupled with a portion of the payload 20).

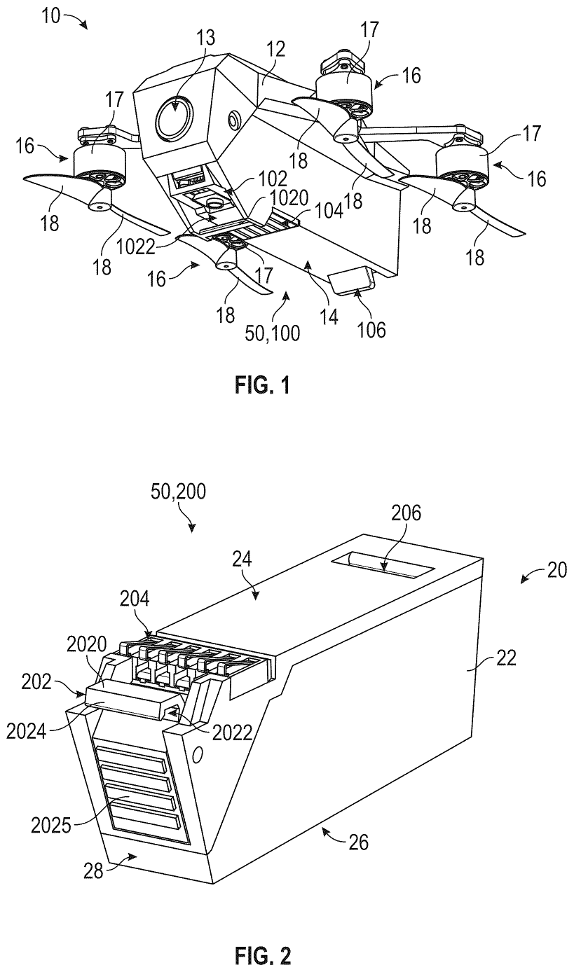

The vehicle 10 can include a body 12 and one or more propulsion systems 16 that are operable to move and/or propel the vehicle 10 to the desired location and/or path. In some examples, the propulsion system 16 can include one or more motors 17 and one or more rotor blades 18 coupled with the motors 17. The motors 17 can be operable to cause the rotor blades 18 to rotate, which can create lift and cause the vehicle 10 to fly. In some examples, the propulsion system 16 can include a water propellor, an engine and wheels, a jet propulsion system, etc. As illustrated in FIG. 1, the vehicle 10 can include four motors 17 and a plurality of rotor blades 18 coupled with each motor 17. In other examples, one, two, three, or more than four motors 17 and corresponding rotor blades 18 can be included without deviating from the scope of the disclosure. By controlling each motor 17 (e.g., decreasing the speed of one or more motors 17 while increasing the speed of other motors 17), the flight path of the vehicle 10 can be adjusted. In some examples, the direction that each of the rotor blades 18 face can be adjusted to change the direction of the flight of the vehicle 10.

In at least one example, the vehicle 10 can be operable to fly a predetermined amount of time (e.g., up to 10 minutes, up to 20 minutes, etc.). The vehicle 10 can be operable to fly up to a predetermined speed, for example less than 2 miles per hour, less than 4 miles per hour, less than 6 miles per hour, less than 8 miles per hour, less than 20 miles per hour, etc. The vehicle 10 can be operable to have a flight mode that includes waypoint enabled autonomous pathing. For example, operators can set specific waypoints for the vehicle 10 to follow, allowing for automated and precise navigation through predefined routes. In some examples, the vehicle 10 can have a flight mode that includes first person viewpoint mode with object avoidance sensing, where the operator can control the flight of the vehicle 10 via the control component 20.

The vehicle 10 can include one or more sensors 13 that can capture data regarding the environment, for example location, proximity, obstacles, weather conditions, explosives, signals (e.g., communication and/or transmitted data signals), etc. For example, as illustrated in FIG. 1, the vehicle 10 can include at least one camera 13 that is operable to capture images and/or video of the surroundings of the vehicle 10. In some examples, the camera(s) 13 can be operable to capture high resolution images and/or videos, night vision images and/or videos, and/or thermal images and/or videos.

For example, with thermal optics, the vehicle 10 can significantly enhance surveillance capabilities. These thermal optics enable the vehicle 10 to detect and locate heat signatures emitted by living beings, vehicles, or equipment, making them invaluable tools for military operations. Thermal imaging works by capturing the infrared energy or heat radiated by objects and converting it into an electronic signal, which is then processed to produce a thermal image on a display. This technology enables the vehicle 10 to see through darkness, smoke, and even certain types of cover, such as foliage or light walls. Accordingly, the vehicle 10 can be operable to operate efficiently, regardless of the time of day or the visibility conditions.

An exemplary application of thermal imaging in a military context is threat detection. With their advanced thermal optics, the vehicle 10 can scan a wide area and identify potential threats based on their heat signatures. This could include enemy personnel hiding in the cover of darkness or vehicles that might be concealed by camouflage. The ability to detect these threats at a safe distance enhances the safety of warfighters and increases the chances of mission success. Moreover, thermal optics can be instrumental in search and rescue missions. For instance, if there are hostages or wounded personnel in a particular area, the heat signatures emitted by their bodies can help the vehicle 10 locate them quickly, even if they are inside a building or hidden under debris. This swift detection can greatly aid rescue efforts, ensuring that help reaches those in need as quickly as possible.

Another exemplary application of thermal optics is in the assessment of enemy encampments or structures. By identifying the heat signatures within these structures, the vehicle 10 can provide valuable information about the number of occupants, their movements, and the potential location of equipment or weapons. This data can provide military forces with a strategic advantage, enabling them to plan their operations with a more comprehensive understanding of the enemy's capabilities and intentions.

In at least one example, the vehicle 10 can include GPS integration. Accordingly, the vehicle 10 can operate indoors as well as efficiently operate outdoors, providing precise positioning and/or navigation. In at least one example, the vehicle 10 can autonomously observe its surroundings and relay real-time data and/or recordings to the operator, making the vehicle 10 ideal for surveillance or inspection tasks.

In some examples, the sensors 13 (for example, the camera) can provide real-time data to the operator, such that decisions and/or adjustments can be made in real-time. Accordingly, the vehicle 10 can expand the battlefield awareness and operational reach of military forces. For example, the vehicle 10 can be adept at performing reconnaissance missions in a variety of challenging environments, from the dense foliage of forests and rugged mountainous terrains to intricate urban landscapes and potentially hostile structures. The vehicle 10 can navigate and adapt to these environments with ease, capturing high-resolution images and videos that feed valuable real-time information back to the operator. The video feeds can be displayed on multiple screens, allowing for concurrent monitoring by various stakeholders. This facilitates informed decision-making, enabling military forces to strategize and respond effectively to emerging situations. The real-time data provided by the vehicle 10 can allow for immediate threat assessment, rapid course correction, and efficient resource allocation, providing a significant tactical advantage in battlefield scenarios.

The vehicle 10 and the payload 20 can together include a coupling mechanism 50 that is operable to couple the payload 20 with the vehicle 10 and provide an easy and simple release mechanism without relying on electrical signals or power to release the payload 20. The coupling mechanism 50 can include a vehicle coupling mechanism 100 and a payload coupling mechanism 200.

The vehicle 10 can include the vehicle coupling mechanism 100. The vehicle coupling mechanism 100 can be provided on, formed by, and/or proximate to a bottom surface 14 of the body 12 of the vehicle 10. The vehicle coupling mechanism 100 can include a latch mechanism 102 to releasably couple the payload 20 with the vehicle 10. The latch mechanism 120 can include a latch bar 1020 and a latch pocket 1022. The latch bar 1020 can extend from the body 12 of the vehicle 10. The latch pocket 1022 can be formed by the area and/or recess between the latch bar 1020 and the body 12 of the vehicle 10. In at least one example, the latch bar 1020 can extend substantially horizontally.

In at least one example, the vehicle coupling mechanism 100 can include an alignment fin 106. The alignment fin 106 can be operable to assist with ensuring that the payload 20 is aligned with the vehicle 10 such that the coupling mechanism 50 can easily and efficiently couple the payload 20 with the vehicle 10. The alignment fin 106 can extend from the bottom surface 14 of the body 12 of the vehicle 10. In some examples, the alignment fin 106 can extend from the bottom surface 14 at an angle in relation to the bottom surface 14. The angle can be between about 15 degrees and about 165 degrees.

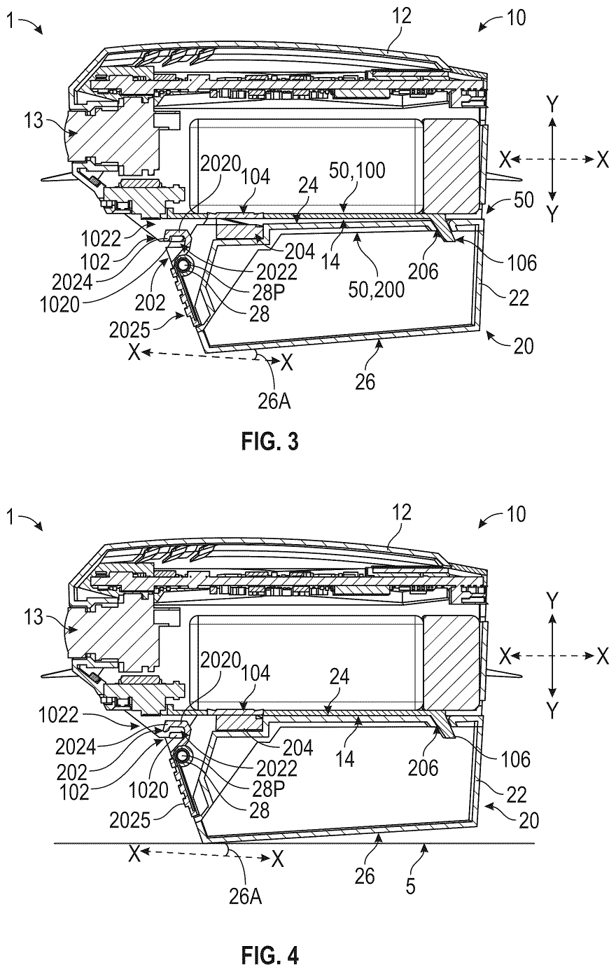

Referring to FIG. 2, the payload 20 can include a body 22 that forms a top surface 24 and a bottom surface 26 opposite the top surface 24. As shown in FIGS. 3-5, when the payload 20 is coupled with the vehicle 10, at least a portion of the top surface 24 is configured to be proximate to and/or abut against the bottom surface 14 of the vehicle 10.

The payload 20 can include a payload coupling mechanism 200 operable to couple with the vehicle coupling mechanism 100 of the vehicle 10. The payload coupling mechanism 200 can include the latch mechanism 202 that corresponds with the latch mechanism 102 of the vehicle 10. The latch mechanism 202 includes a spring-loaded latch 2020 operable to transition between a locked configuration and an unlocked configuration. The spring-loaded latch 2020 can correspond with and be operable to couple with the latch bar 1020 of the vehicle 10. The spring-loaded latch 2020 can include a latch arm 2024 that forms a latch recess 2022. The latch arm 2024 with the latch recess 2022 is operable to at least partially receive the latch bar 1020 when the spring-loaded latch 2020 is in the locked configuration. As shown in FIGS. 3-5, the spring-loaded latch 2020 can include a spring 28 that applies a force against the latch arm 2024 such that the spring-loaded latch 2020 is loaded towards the unlocked configuration. The spring 28 can include a torsion spring operable to provide rotational force. In some examples, the spring-loaded latch 2020 can be operable to rotate about a pivot point 28P to transition between the locked configuration and the unlocked configuration.

An attachment button 2025 can be coupled with and/or integral with the spring-loaded latch 2020. The attachment button 2025 can be operable to assist in transitioning the spring-loaded latch to the locked configuration. For example, the attachment button 2025 can receive a force (e.g., from an operator and/or from a motor) to push against the force from the spring 28. Accordingly, the spring-loaded latch 2020 and the latch arm 2024 rotate to the locked configuration.

To couple the spring-loaded latch 2020 with the latch bar 1020, the spring-loaded latch 2020 can be in the unlocked configuration. The latch arm 2024 can be received in and/or pass through the latch pocket 1022. The latch bar 1020 is then received in the latch recess 2022. The attachment button 2025 can cause the spring-loaded latch 2020 to rotate to the locked configuration such that the latch bar 1020 is securely received in the latch recess 2022, and the latch arm 2024 prevents undesired movement of the latch bar 1020 within the latch recess 2022.

When the spring-loaded latch 2020 transitions to the unlocked configuration, the latch arm 2024 can move (e.g., rotate) such that the latch bar 1020 is released.

In at least one example, the attachment button 2025 and the latch mechanism 202 can be proximate and/or extend from a front surface 28 of the payload 20.

In at least one example, the payload coupling mechanism 200 can include an alignment receiving portion 206. In some examples, the alignment receiving portion 206 can include an aperture, a groove, and/or a recess formed in the body 22 of the payload 20. In some examples, the alignment receiving portion 206 can be formed in the top surface 24 of the body 22 of the payload 20. The alignment receiving portion 206 is operable to receive the alignment fin 106 and prevent undesired rotation and/or movement of the payload 20 in relation to the vehicle 10.

The disclosure discusses that the vehicle 10 includes the latch bar 1020, latch pocket 1022, and alignment fin 106, and the payload 20 includes the spring-loaded latch 2020 and the alignment receiving portion 206. In some examples, the components of the coupling mechanism 50 can be interchanged between the vehicle 10 and the payload 20 without deviating from the scope of the disclosure.

In at least one example, the vehicle 10 and/or the payload 20 can include a tension connection 104, 204. The tension connection 104, 204 can be operable to hold the latch mechanism 102, 202 under a tension force. The tension force can be one that pushes the payload 20 away from the vehicle 10. For example, the tension force by the tension connection 104, 204 can push the top surface 24 of the payload 20 away from the bottom surface 14 of the vehicle 10. Accordingly, referring to FIGS. 1-3, when the spring-loaded latch 2020 is coupled with the latch bar 1020, the latch bar 1020 is pressed against the latch arm 2024 into the latch recess 2022, keeping the latch mechanism 102, 202 engaged to securely couple the payload 20 with the vehicle 10.

In at least one example, the tension connection includes one or more contacts 104, 204. In some examples, the vehicle 10 can include one or more contacts 104. In some examples, the payload 20 can include one or more contacts 204. The contacts 104, 204 can be operable to communicatively connect and/or electrically connect the vehicle 10 with the payload 20. The tension connection 104, 204 can be operable to transmit power and/or signals between the vehicle 10 and the payload 20. In some examples, at least one contacts 104, 204 can be spring loaded and/or pressure loaded to provide the tension force which pushes the payload 20 away from the vehicle 10.

In some examples, the contacts 104, 204 can include a dual-row, through-hole connector used for cable-to-board applications in electronic systems. The contacts 104, 204 can include a specific pin configuration, designed to securely connect to a corresponding female connector or cable, ensuring proper alignment through its standard pitch. The contacts 104, 204 can be made of conductive metals, such as gold or tin-plated copper, providing reliable electrical contact for signal and/or power transmission. The spring-loaded and/or pressure contact(s) 104, 204 in the tension connection can ensure low-resistance connections while offering durability over many mating cycles, making it suitable for both low and high-performance applications.

In at least one example, as shown in FIGS. 3-5, The bottom surface 26 of the payload 20 can extend at an angle 26A in relation to a longitudinal axis X-X. For example, the front surface be longer (e.g., between the top surface 24 and the bottom surface 26) than the rear surface. The angle 26A can be between about 1 degree and about 89 degrees. The angle 26A allows for the front surface 28 to abut against a surface (e.g., the ground, a table, a roof top, etc.) first to counter against the tension force from the tension connection 104, 204.

FIGS. 3-5 illustrate the payload 20 being detached from the vehicle 10 to be deployed.

FIG. 3 illustrates the payload 20 in the fully locked configuration on the underside of the vehicle 10. As can be seen in FIG. 3, the alignment fin 106 is angled to hinder any rotational motion clockwise around the front latch mechanism 102, 202. In some examples, one or more additional alignment fins can be provided on either side of the front latch mechanism 102, 202. These additional alignment fins can keep the payload 20 in place and also hinder any pulling action to release the payload 20 from the vehicle 10 unintentionally. Also, as shown in FIG. 3, the tension connection 104, 204 provides the constant tension force that separates the top surface 24 of the payload 20 from the bottom surface 14 of the vehicle 10, keeping the latch mechanism 102, 202 engaged.

FIG. 4 illustrates the bottom surface 26 of the payload 20 being vertically compressed. The sloped bottom surface 26 helps ensure the front of the payload 20 is what contacts the surface 5 first, which compresses the tension connection contacts 104, 204 until the bottom surface 14 of the vehicle 10 is in or near full contact with the top surface 24 of the payload 24. While the disclosure discusses the front of the payload 20 being contacted first, in other examples, the payload 20 can be configured so that the portion of the bottom surface 26 that is aligned with the latch mechanism 102, 202 contacts the surface 5 first.

When the bottom surface 26 of the payload 20 abuts against the surface 5, the spring-loaded latch 2020 can transition to the unlocked configuration such that the payload 20 is releasable from the vehicle 10. When the bottom surface 26 of the payload 20 abuts against the surface 5 and the vehicle 10 provides a downward force on the payload 20 against the surface 5, the tension connection 104, 204 can be compressed to overcome the tension force. In some examples, the payload 20 can receive a release force (for example from the surface 5 and/or the vehicle 10) such that the top surface 24 of the payload 20 is moved closer to the bottom surface 14 of the vehicle 10. When the top surface 24 of the payload 20 approaches the bottom surface 14 of the vehicle 10, the tension connection 104, 204 can be compressed to overcome the tension force, and the latch mechanism 102, 202 can be released.

In at least one example, when the payload 20 receives the release force, the payload 20 can pivot about the alignment mechanism 106, 206 to overcome the tension force. In some examples, the bottom surface 26 of the payload 20 can extend at an angle 26A in relation to a longitudinal axis X-X so that the longer side is opposite the alignment mechanism 106, 206. For example, the front surface of the payload 20 can be longer than the back surface of the payload 20, and the alignment mechanism 106, 206 can be positioned at, near, or adjacent to the back surface of the payload 20. In some examples, the tension connection 104, 204 can be provided near the front surface of the payload 20 while the alignment mechanism 106, 206 can be provided near the back surface of the payload 20. In some examples, the tension connection 104, 204 can be provided near the back surface of the payload 20 while the alignment mechanism 106, 206 can be provided near the front surface of the payload 20. Accordingly, as the payload 20 pivots about the alignment mechanism 106, 206, the tension connection 104, 204 is being compressed to overcome the tension force which can allow the latch mechanism 102, 202 to be released.

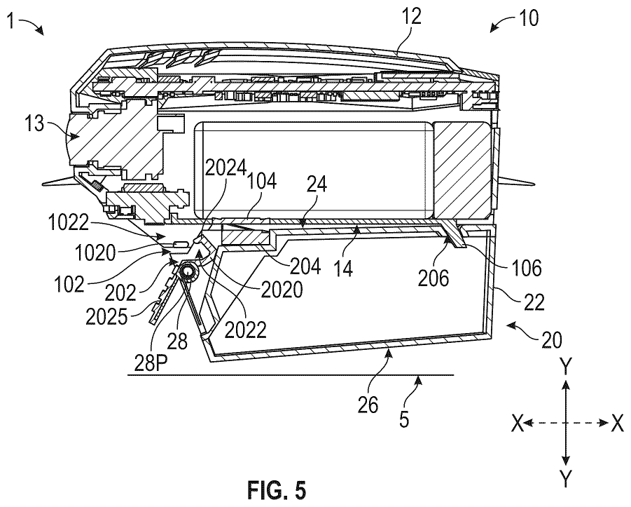

For example, in FIG. 4, viewing the latch mechanism 102, 202 from the side of the payload 20, the latch arm 2024 is no longer interfering with the latch bar 1020 of the vehicle 10. The latch arm 2024 is pushed into the latch pocket 1022 away from the latch bar 1020. Accordingly, the latch bar 1020 is no longer abutting against and engaged with the latch arm 2024, and the latch bar 1020 is moved out of the latch recess 2022. As such, the spring 28 (shown as wrapped around the rotational axis 28P of the latch arm 2024) can spring back (e.g., to about 90 degrees), forcing the latch arm 2024 to move back and free of the latch bar 1020, as shown in FIG. 5.

FIG. 5 illustrates that after the spring-loaded latch 2020 transitions to the unlocked configuration, when the vehicle 10 lifts away from the surface 5 (for example, the bottom surface 14 of the vehicle 10 is moved away from the top surface 24 of the payload 20), the payload 20 can be released and remain on the surface 5.

After the latch arm 2024 is moved free of the latch bar 1020, the vehicle 10 is able to fly vertically (e.g., along the vertical axis Y-Y) away from the payload 20. The alignment fin 106 can be able to slide free out of the alignment receiving portion 206. This action can leave the payload 20 behind on the surface 5 and leaves the vehicle 10 completely free of any connection.

The coupling mechanism 50 allows for a physical, automatic disengagement of the payload 20 from the vehicle 10 without the need of any signals, motors, etc. The coupling mechanism 50 allows for the simple act of lowering the payload 20 onto the surface 5 by the vehicle 10 to disengage and deploy the payload 20.

The attachment of the payload 20 to the vehicle 10 can be done in the reverse order of FIGS. 3-5, inserting the alignment fin 106 into the alignment receiving portion 206, then pressing down on the attachment button 2025. This can index the latch arm 2024 with the latch bar 1020, which is then held in place by the tension force supplied by the tension connection 104, 204.

The disclosures shown and described herein are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the examples described herein may be modified within the scope of the appended claims.

1. A coupling mechanism for coupling a vehicle with a payload, the coupling mechanism comprising:
a latch mechanism that includes a spring-loaded latch, the spring-loaded latch operable to transition between a locked configuration and an unlocked configuration; and
a tension connection operable to hold the latch mechanism under a tension force,
wherein when the payload receives a release force, the spring-loaded latch transitions to the unlocked configuration such that the payload is releasable from the vehicle.

2. The coupling mechanism of claim 1, wherein the latch mechanism includes a latch bar, wherein the spring-loaded latch includes a latch arm, wherein the latch arm is operable to at least partially receive the latch bar when the spring-loaded latch is in the locked configuration.

3. The coupling mechanism of claim 2, wherein when the spring-loaded latch transitions to the unlocked configuration, the latch arm moves such that the latch bar is released.

4. The coupling mechanism of claim 1, wherein when the bottom surface of the payload abuts against a surface to receive the release force, the release force causes the tension connection to be compressed to overcome the tension force.

5. The coupling mechanism of claim 1, wherein the tension connection includes one or more contacts which communicatively connects and/or electrically connects the vehicle with the payload.

6. The coupling mechanism of claim 5, wherein at least one contact of the one or more contacts is spring loaded and/or pressure loaded to provide the tension force which pushes the payload away from the vehicle.

7. The coupling mechanism of claim 1, further comprising: an alignment mechanism including an alignment fin and an alignment receiving portion, wherein the alignment fin is operable to be received in the alignment receiving portion.

8. The coupling mechanism of claim 1, wherein after the spring-loaded latch transitions to the unlocked configuration, when the vehicle lifts away so that the bottom surface of the vehicle is moved away from the top surface of the payload, the payload is released and remains on the surface.

9. The coupling mechanism of claim 1, wherein the bottom surface of the payload extends at an angle in relation to a longitudinal axis.

10. The coupling mechanism of claim 1, wherein when the payload receives the release force, a top surface of the payload moves towards a bottom surface of the vehicle.

11. A payload comprising:
a latch mechanism that couples with a vehicle, the latch mechanism including a spring-loaded latch, the spring-loaded latch operable to transition between a locked configuration and an unlocked configuration; and
a tension connection operable to hold the latch mechanism under a tension force against the vehicle,
wherein when the payload receives a release force, the spring-loaded latch transitions to the unlocked configuration such that the payload is releasable from the vehicle.

12. The payload of claim 11, wherein the spring-loaded latch includes a latch arm, wherein the latch arm is operable to at least partially receive a latch bar of the vehicle when the spring-loaded latch is in the locked configuration.

13. The payload of claim 12, wherein when the spring-loaded latch transitions to the unlocked configuration, the latch arm moves such that the latch bar is released.

14. The payload of claim 1, wherein when the bottom surface of the payload abuts against a surface to receive the release force, the release force causes the tension connection to be compressed to overcome the tension force.

15. The payload of claim 1, wherein the tension connection includes one or more contacts which communicatively connects and/or electrically connects the vehicle with the payload.

16. The payload of claim 15, wherein at least one contact of the one or more contacts is spring loaded and/or pressure loaded to provide the tension force which pushes the payload away from the vehicle.

17. The payload of claim 11, further comprising: an alignment mechanism including an alignment receiving portion operable to receive an alignment fin of the vehicle so that when the payload receives the release force, the payload pivots about the alignment mechanism to overcome the tension force.

18. The payload of claim 11, wherein a bottom surface of the payload extends at an angle in relation to a longitudinal axis.

19. The payload of claim 11, wherein when the payload receives the release force, a top surface of the payload moves towards a bottom surface of the vehicle.

20. A vehicle comprising:
a latch mechanism including a latch bar that is operable to be received by a spring-loaded latch of a payload to couple the vehicle with the payload;
a tension connection operable to hold the latch mechanism under a tension force; and
an alignment mechanism including an alignment fin operable to be received in an alignment receiving portion of the payload,
wherein when the payload receives a release force, the payload pivots about the alignment mechanism in relation to the vehicle to overcome the tension force, and the spring-loaded latch transitions to the unlocked configuration such that the payload is releasable from the vehicle.
